(19) United States
(12) Patent Application Publication
(10) Pub. No.: US 2024/0047727 A1
(43) Pub. Date: Feb. 8, 2024

(54) FUEL CELL STACK WITH COMPRESSIBLE FABRIC STRUCTURE

(71) Applicant: AUDI AG, Ingolstadt (DE)

(72) Inventors: Markus GRETZER, Eichstätt (DE); Norbert KLUY, Schernfeld (DE)

(21) Appl. No.: 18/257,280

(22) PCT Filed: Apr. 7, 2022
(86) PCT No.: PCT/EP2022/059253

§ 371 Date: Jun. 13, 2023

(30) Foreign Application Priority Data
Apr. 12, 2021 (DE) 10 2021 108 981.6

(51) Int. Cl. H01M 8/248; H01M 8/0202

(52) U.S. Cl. CPC H01M 8/248; H01M 8/0202

(57) ABSTRACT

A fuel cell stack is provided comprising a plurality of fuel cells stacked on top of one another along a stacking direction. At least one of the fuel cells comprises at least one compressible fabric structure, having a spring function with a spring constant. With the spring function, a change in length of the fuel cell along the stacking direction can be equalized by an opposite and negative change in length of the compressible fabric structure.

### BACKGROUND

### Technical Field

Embodiments of the present disclosure relate to a fuel cell stack having a plurality of fuel cells stacked on top of one another along a stacking direction.

### Description of the Related Art

Fuel cell devices are used for the chemical transformation of a fuel with oxygen to form water in order to create electric energy. For this, fuel cells contain as their key component the so-called membrane electrode assembly (MEA), which is an assemblage of a proton-conducting membrane and an electrode arranged on either side of the membrane (anode and cathode). Furthermore, gas diffusion layers (GDL) may be arranged on either side of the membrane electrode unit at the sides of the electrodes facing away from the membrane. In operation of the fuel cell device having a plurality of fuel cells assembled into a fuel cell stack, the fuel, such as hydrogen H₂ or a gas mixture containing hydrogen, is supplied to the anode, where an electrochemical oxidation of H₂ to H⁺ takes place, giving off electrons. Through the electrolyte or the membrane which separates the reaction spaces from each other gas-tight and electrically insulates them, a transport of the protons H⁺ from the anode space to the cathode space occurs. The electrons provided at the anode are taken by an electrical line to the cathode. The cathode is supplied with oxygen or a gas mixture containing oxygen, so that a reduction of O₂ to O₂⁻ occurs, taking up electrons. At the same time, these oxygen anions react in the cathode space with the protons transported across the membrane to form water.

The document DE 10 2005 022 484 A1 shows a gas diffusion layer in which a layer of compressible fabric is integrated, which is supposed to prevent the gas diffusion layer from pressing into the gas ducts of the bipolar plate.

The document DE 100 427 44 A1 discloses a gas distribution layer for a fuel cell stack, composed of a compressible fabric, in order to increase the cell resistance by a defined compression of the gas distribution layer.

The document DE 43 401 53 C1 discloses an electrically conductive, elastic and gas-permeable contact cushion having a deformable surface structure. The contact cushion serves for equalizing irregularities in the surface of the electrodes.

In one typical design of the fuel cell stack, the fuel cells or unit cells stacked one on top of another are held together by fixation elements, such as bands, on the outside. These fixation elements are secured to both end-position fuel cells of the fuel cell stack and hold them at a defined and constant spacing from each other.

The drawback here is that the length of the stacked cells does not remain constant during operation. This means, in particular, that the implementing and positioning of terminals is more difficult, such as are required, for example, for the monitoring of the cell potentials.

### BRIEF SUMMARY

Some embodiments provide a fuel cell stack which enables a constant stack length in all operating states.

The fuel cell stack is characterized in that at least one of the fuel cells comprises at least one compressible fabric structure, having a spring function with a spring constant, and that by the spring function a change in length of the fuel cell along the stacking direction can be equalized by an opposite and negative change in length of the compressible fabric structure.

In other words, the spring function of the compressible fabric structure enables a length equalization of the fuel cells, in all operating states, so that the fuel cells always have a defined length in the stacking direction regardless of the operating state. A lengthening of the fuel cell in the stacking direction, due to thermal expansion or due to a hydrostatic change in length, which results in a bulging of the membrane electrode assembly, can thus be fully equalized by the compressing of the compressible fabric structure. In this case, the thermal or hydrostatic change in length produces a pressure increase between the layers, so that the spring function of the compressible fabric structure is activated and presses them together. The spring function of the compressible fabric structure thus prevents any damaging of the components of the fuel cell and the fuel cell stack due to excessively large pressures. Consequently, a specific pressing force acts within the fuel cell stack between the two end-position fuel cells, being constant over all operating modes of the fuel cell stack. Furthermore, a constant stack length and pressing force over all operating states enables an implementation of the cell potential monitoring in the fuel cell stack, since the cable length can be implemented without any reserve loops. This leads to a reduction in the required design space. A further benefit of a fuel cell stack length which is constant over all operating states is that the length of all current-carrying parts can be held constant, such as the length of the current busbars.

In some embodiments, each of the fuel cells may comprise at least one compressible fabric structure with associated spring function.

Furthermore, different fuel cells may have compressible fabric structures which differ in their spring constant. This makes it possible to use different compressible fabric structures in different regions of the fuel cell stack, so that the spring constant in the middle, i.e., the core of the fuel cell stack, can be chosen somewhat different from that at the ends of the fuel cell stack. In this way, an individual adapting and control of the pressing force over different regions of the fuel cell stack is achieved.

In some embodiments, the compressible fabric structure may be formed from interwoven fibers, and the spring function may be produced by a nonordered arrangement of the fibers. In one embodiment, the spring function is produced by an ordered arrangement of the fibers. Alternatively, or additionally, the compressible fabric structure may be formed by wave-shaped fibers which provides the spring function. The fibers of the fabric structure are consequently not interwoven, but instead they are wave-shaped. In some embodiments, the mean amplitude of the wave-shaped fibers is higher than the mean amplitude of the fibers of the woven fabric structure. The compressible fabric structure can also have an irregular structure, that is, the amplitudes of the wave-shaped fibers differ along the fabric structure.

Alternatively, or additionally, the fabric structure may be formed from interwoven fibers having a mean first amplitude, and a wave-shaped resilient fiber may be present to provide the spring function, being associated with the fibers of the fabric structure or interwoven with them, and for its mean second amplitude to be greater than the mean first amplitude of the fibers of the fabric structure.

In order to provide in easy manner the spring function with associated spring constant, the fiber providing the spring function may be at least partly formed of a plastic or a metal.

The pressing force acting between the end-position fuel cells can then be controlled individually for each fuel cell and also within the fuel cell in that the compressible fabric structure has a first region associated with the first spring constant and a second region associated with a second spring constant different from the first spring constant. The compressible fabric structure can also have more than two regions differing in their spring constant.

For an implementation of the compressible fabric structure, in some embodiments the fuel cells may each have an active region, for there to be present a first media guide for transport of a first reactant into and/or out from the active region, a second media guide for transport of a second reactant into and/or out from the active region, and a third media guide for transport of coolant into and/or out from the active region, and for the compressible fabric structure to be associated with or arranged in at least one of the media guides. The media guide may be formed as a flow field.

In this regard, a plurality of the media guides may have the compressible fabric structures, and different spring constants may be associated with the compressible fabric structures of the different media guides. In this way, the spring action in the individual media guides or media spaces can be organized and thus adjusted differently. This allows one to deal with the specific boundary conditions of the different media guides. Thus, for example, the size of the media spaces transporting or holding the reactants, i.e., the anode space and the cathode space, can be kept approximately constant in size, in order to assure the supply of the fuel and the air to the active region also in a hydrostatic state. On the other hand, the third media space holding the coolant may be the most compressible, and thus it has a lower spring constant than the spring constant of the other media spaces. Hence, the compressible fabric structure may be associated with or arranged in at least the third media guide transporting the coolant.

The features and combinations of features mentioned above in the description as well as the features and combinations of features mentioned below in the description of the figures and/or shows solely in the figures can be used not only in the particular indicated combination, but also in other combinations or standing alone. Thus, embodiments not shown or explained explicitly in the figures, yet deriving and producible from the explained embodiments by separated combinations of features shall also be deemed to be encompassed and disclosed by the present disclosure.

### BRIEF DESCRIPTION OF THE SEVERAL VIEWS OF THE DRAWINGS

Further benefits, features and details will emerge from the claims, the following description of embodiments, and the drawings.

FIG. 1 shows a schematic representation of a noncompressed fuel cell stack.

FIG. 2 shows a schematic representation of a compressed fuel cell stack.

FIG. 3 shows a schematic representation of a compressible fabric structure.

FIG. 4 shows a schematic representation of an alternative embodiment of the compressible fabric structure.

### DETAILED DESCRIPTION

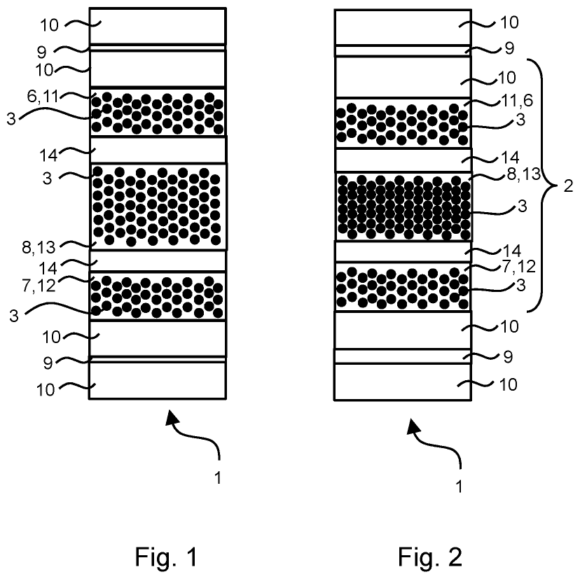

FIG. 1 shows a fuel cell stack 1 with a plurality of fuel cells, which can be formed as unit cells. Each fuel cell 2 is formed from a membrane electrode assembly 9 having an active region, being associated on the anode side and the cathode side with a respective bipolar plate 14. Furthermore, between the membrane electrode assembly 9 and the bipolar plates 14 there is arranged on the cathode side and the anode side a respective gas diffusion layer 10. The bipolar plate 14 is formed from two single plates, joined together, one of which provides a first media guide 6, i.e., a cathode flow field 11, and the other provides a second media guide 7, i.e., an anode flow field 12. In between there is formed a third media guide 8, namely, a coolant flow field 13. There is associated with or arranged in each media guide 6, 7, 8 a compressible fabric structure 3, which is assigned a spring function with a spring constant. The spring function makes it possible for a change in length of the fuel cell 2 along a stacking direction to be equalized by an oppositely directed negative change in length of the compressible fabric structure 3. In other words, the spring function of the compressible fabric structure 3 makes possible an equalization of length of the fuel cell 2 in all operating states, so that the fuel cells 2 and thus the fuel cell stack 1 always have a defined length in the stacking direction, regardless of the operating state.

FIG. 2 shows the fuel cell stack 1 in which the compressible fabric structures 3 are partly compressed. Due to a thermal or hydrostatic stretching, for example of the membrane electrode assembly 9, a pressure increase will occur between the end-position fuel cells 2 of the fuel cell stack 1. This pressure increase will be equalized by a compression of the compressible fabric structure 3, so that inside the fuel cell stack 1 there will be acting between the two end-position fuel cells a specific pressing force which is constant over all operating modes of the fuel cell stack 1, and the length of the fuel cell stack will likewise remain constant.

However, FIG. 2 also reveals that the compressible fabric structures 3 can have different spring constants. Thus, the spring action can be organized differently and thus be adjustable in the individual media guides 6, 7, 8 or flow fields 11, 12, 13. In the present case, the fabric structures 3 of the first media guide 6 and the second media guide 7, i.e., those of the anode flow field 11 and the cathode flow field 12, have a higher spring constant than those of the third media guide 8, i.e., the coolant flow field 13. Consequently, the compressible fabric structure of the coolant flow field 13 is compressed the most, while the fabric structure 3 associated with or arranged in the anode flow field 12 and the cathode flow field 11 is only slightly compressible. In this way, the size of the anode spaces and the cathode spaces remains approximately constant, still with constant pressing force and constant fuel cell stack length.

Furthermore, it is also possible for different fuel cells 2 within the fuel cell stack 1 to have compressible fabric structures 3 with different spring constants. For example, the spring constants in the middle, or core of the fuel cell stack 1, can be chosen different from those at the ends of the fuel cell stack 1.

Furthermore, the compressible fabric structures 3 can also have a first region associated with a first spring constant and a second region associated with a second spring constant, different from the first spring constant.

In FIGS. 1 and 2, the spring function of the compressible fabric structure 3 is formed by a regular arrangement of interwoven fibers 4. Alternatively, but not shown, the spring function could also be provided by an irregular arrangement of interwoven fibers 4.

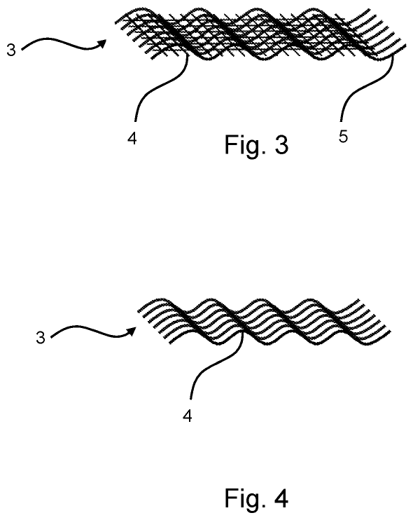

An alternative embodiment of the compressible fabric structure 3 is shown in FIG. 3. Here, the compressible fabric structure 3 comprises interwoven fibers 4 having a mean first amplitude. In order to provide a spring function, wave-shaped resilient fibers 5 having a mean second amplitude are present. The mean second amplitude here is greater than the mean first amplitude, so that a spring function with a spring constant can be provided by the resilient fiber 5.

FIG. 4 shows an alternative embodiment of the compressible fabric structure 3, in which the spring function is provided by the fibers 4 themselves being wave-shaped, i.e., not interwoven.

The fibers 4,5 providing the spring function are at least partly formed from a plastic or a metal.

Aspects of the various embodiments described above can be combined to provide further embodiments. In general, in the following claims, the terms used should not be construed to limit the claims to the specific embodiments disclosed in the specification and the claims, but should be construed to include all possible embodiments along with the full scope of equivalents to which such claims are entitled.

1. A fuel cell stack, comprising:
a plurality of fuel cells stacked on top of one another along a stacking direction, wherein at least one of the fuel cells comprises at least one compressible fabric structure, having a spring function with a spring constant, and that by the spring function a change in length of the fuel cell along the stacking direction can be equalized by an opposite and negative change in length of the compressible fabric structure.

2. The fuel cell stack according to claim 1, wherein each of the fuel cells comprises at least one compressible fabric structure with associated spring function.

3. The fuel cell stack according to claim 1, wherein the compressible fabric structure is formed from interwoven fibers, and the spring function is produced by a nonordered arrangement of the fibers.

4. The fuel cell stack according to claim 1, wherein the compressible fabric structure is formed by wave-shaped fibers which provide the spring function.

5. The fuel cell stack according to claim 1, wherein the compressible fabric structure is formed from interwoven fibers having a mean first amplitude, and that a wave-shaped resilient fiber having a mean second amplitude is present to provide the spring function, being associated with the fibers of the fabric structure or interwoven with them, and the mean second amplitude is greater than the mean first amplitude.

6. The fuel cell stack according to claim 3, wherein the fiber providing the spring function is at least partly formed of a plastic or a metal.

7. The fuel cell stack according to claim 1, wherein the compressible fabric structure has a first region associated with the first spring constant and a second region associated with a second spring constant different from the first spring constant.

8. The fuel cell stack according to claim 1, wherein the fuel cells each have an active region, there is present a first media guide for transport of a first reactant into and/or out from the active region, a second media guide for transport of a second reactant into and/or out from the active region, and a third media guide for transport of coolant into and/or out from the active region, and the compressible fabric structure is associated with or arranged in at least one of the media guides.

9. The fuel cell stack according to claim 8, wherein the first, second, and third media guides have the compressible fabric structures, and different spring constants are associated with the compressible fabric structures of the different media guides.

10. The fuel cell stack according to claim 8, wherein the compressible fabric structure is associated with or arranged in the third media guide transporting the coolant.
